(19) United States
(12) Patent Application Publication
(10) Pub. No.: US 2024/0408850 A1
(43) Pub. Date: Dec. 12, 2024

(54) FILM STRUCTURE FOR WINDOW GLASS, AND WINDOW

(71) Applicant: Hui Chen, Shanghai (CN)

(72) Inventor: Hui Chen, Shanghai (CN)

(21) Appl. No.: 18/764,286

(22) Filed: Jul. 4, 2024

(30) Foreign Application Priority Data
Jun. 8, 2023 (CN) 2023214569652

(51) Int. Cl. B32B 17/10; B32B 33/00; B32B 37/26

(52) U.S. Cl. CPC B32B 17/10; B32B 33/00; B32B 37/26; B32B 2037/268; B32B 2255/10; B32B 2307/7376

(57) ABSTRACT

Embodiments of the present disclosure provide a film structure for a window glass, and a window, and relate to the field of glass films. The film structure for a window glass includes: a substrate layer, comprising a transparent film layer and a backing paper layer, the transparent film layer being disposed on the backing paper layer; and a pattern layer disposed on a surface of the transparent film layer facing away from the backing paper layer, a plurality of transparent relief units being disposed on a surface of the pattern layer facing away from the transparent film layer, and a spacing being left between some of adjacent transparent relief units. After light passes through the film structure for a window glass, a good diffuse reflection effect can be produced, so that the 3D effect of fired art glass can be more realistically presented.

### TECHNICAL FIELD

Embodiments of the present disclosure relate to the technical field of glass films, and in particular, to a film structure for a window glass, and a window.

### BACKGROUND

In daily life, when people need sufficient light while needing to protect indoor privacy, window films are typically attached to window glass. The window films can provide an effect of blurring the window glass, prevent indoor situations from being observed from the outside through the window glass, and thus meet people's needs for protecting indoor privacy. In addition, compared with window curtains, the window films can allow more light to enter rooms, so as to meet people's needs. However, existing window films are of a planar structure, causing most of the light passing through the window films to have a direct transmission effect, and the diffuse reflection effect of the light is poor, so that the window films finally have no three-dimensional effect, and cannot meet the requirements of more users.

### SUMMARY

In order to overcome the shortcomings of the prior art, embodiments of the present disclosure provide a film structure for a window glass, and a window. After light passes through the film structure for a window glass, a good diffuse reflection effect can be produced, so that the 3D effect of fired art glass can be more realistically presented.

The embodiments of the present disclosure are implemented by adopting the following technical solutions.

In a first aspect, the embodiments of the present disclosure provide a film structure for a window glass. The film structure for a window glass includes: a substrate layer, comprising a transparent film layer and a backing paper layer, the transparent film layer being disposed on the backing paper layer; and a pattern layer disposed on a surface of the transparent film layer facing away from the backing paper layer, a plurality of transparent relief units being disposed on a surface of the pattern layer facing away from the transparent film layer, and a spacing being left between some of adjacent transparent relief units; wherein a cross section of each of the transparent relief units in a direction perpendicular to the pattern layer is disposed in an arc shape on a side facing away from the pattern layer.

In a second aspect, the embodiments of the present disclosure provide a window. The window includes a glass body and a film structure for a window glass as described above. The film structure for a window glass is disposed on the glass body.

### BRIEF DESCRIPTION OF THE DRAWINGS

FIG. 1 is a schematic structural diagram of a film structure for a window glass according to one embodiment of the present disclosure;

FIG. 2 is a schematic structural diagram of a window according to one embodiment of the present disclosure;

FIG. 3 is a schematic diagram of light passing through a window with a film structure for a window glass according to one embodiment of the present disclosure; and

FIG. 4 is an effect diagram of a film structure for a window glass according to one embodiment of the present disclosure.

List of reference signs: 1. Substrate layer; 2. Transparent film layer; 3. Backing paper layer; 4. Pattern layer; 5. Transparent relief unit; 6. Spacing; 7. Glass body; 8. Blank region.

### DESCRIPTION OF THE PREFERRED EMBODIMENTS

Specific embodiments of the present disclosure will be described in detail in this section. Preferred embodiments of the present disclosure are illustrated in the accompanying drawings. The accompanying drawings serve to supplement the text description of the specification with figures, providing a visual understanding of each technical feature and the overall technical solution of the embodiments of the present disclosure, but cannot be construed as a limitation to the scope of protection of the embodiments of the present disclosure.

In the description of the embodiments of the present disclosure, it should be understood that orientation or position relationships indicated by terms “upper”, “lower”, “front”, “rear”, “left”, “right”, etc. are orientation or position relationships as shown in the accompanying drawings, and these terms are just used to facilitate description of the embodiments of the present disclosure and simplify the description, rather than indicating or implying that the mentioned device or element must have a specific orientation and must be constructed and operated in a specific orientation, and thus cannot be construed as a limitation to the embodiments of the present disclosure.

In the description of the embodiments of the present disclosure, “several” means one or more, “a plurality of” means two or more, “greater than”, “less than”, “over”, etc. are construed as excluding the number, and “above”, “below”, “within”, etc. are construed as including the number. The terms “first” and “second” in the description are merely intended to distinguish technical features, and cannot be construed as indicating or implying relative importance or implicitly indicating a number of the indicated technical features or implicitly indicating a sequence relationship of the indicated technical features.

In the description of the embodiments of the present disclosure, unless otherwise explicitly defined, the words such as “arrange”, “mount” and “connect” should be understood in a broad sense, and those skilled in the art can reasonably determine the specific meanings of the above words in the embodiments of the present disclosure with reference to the specific contents of the technical solutions.

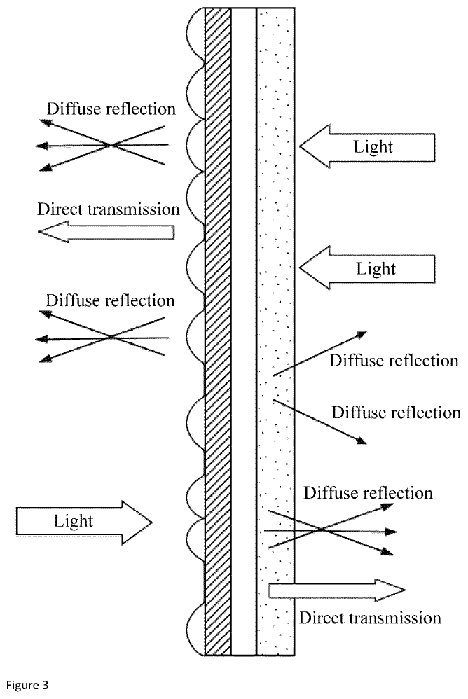

Referring to FIGS. 1 to 4, in the embodiments of the present disclosure, a film structure for a window glass according to a preferred embodiment includes: a substrate layer 1, the substrate layer 1 including a transparent film layer 2 and a backing paper layer 3, and the transparent film layer 2 being disposed on the backing paper layer 3; and a pattern layer 4, the pattern layer 4 being disposed on a surface of the transparent film layer 2 facing away from the backing paper layer 3, a plurality of transparent relief units 5 being disposed on a surface of the pattern layer 4 facing away from the transparent film layer 2, and a spacing 6 being left between some of adjacent transparent relief units 5. A cross section of each of the transparent relief units 5 in a direction perpendicular to the pattern layer 4 is disposed in an arc shape on one side of a surface facing away from the pattern layer 4. As an example, each of the transparent relief units 5 may be disposed in the shape of a spherical surface, each of the transparent relief units 5 may be disposed in an irregular shape, or each of the transparent relief units 5 may also be in other suitable shapes, which is not limited thereto, as long as each of the transparent relief units 5 has a feature that a cross section in a direction perpendicular to the pattern layer 4 is disposed in an arc shape on the side of the surface facing away from the pattern layer 4. The relief units may be configured according to actual requirements. In the embodiments of the present disclosure, the number of transparent relief units 5 is not limited, but may be set according to the actual requirements. According to the film structure for a window glass of the embodiments of the present disclosure, by disposing the plurality of transparent relief units 5 on the surface of the pattern layer 4 facing away from the transparent film layer 2, the film structure for a window glass has a bumpy texture, light passing through each of the transparent relief units 5 is diffusely reflected, and the light passing through the spacing 6 between adjacent transparent relief units 5 is directly transmitted, so that the 3D effect of fired art glass can be more realistically presented. The film structure for a window glass of the embodiments of the present disclosure can present the above effect indoors and outdoors. In addition, by disposing each of the transparent relief units 5 in an arc shape on the side facing away from the pattern layer 4, the light passing through each of the transparent relief units 5 can have a better diffuse reflection effect, and the manufacturing process for each of the transparent relief units 5 can also be more adaptable, making each of the transparent relief units 5 easier to manufacture with a high manufacturing efficiency.

A method for using the film structure for a window glass of the embodiments of the present disclosure includes: peeling off the backing paper layer 3, spraying water to wet a surface of the window glass, attaching the transparent film layer 2 of the film structure for a window glass of the embodiments of the present disclosure onto the window glass, and using a scraper to scrape the film structure for a window glass of the embodiments of the present disclosure on the basis of the principle of atmospheric pressure, such that the film structure for a window glass of the embodiments of the present disclosure is flatly attached to the surface of the window glass.

A preferred embodiment of the film structure for a window glass in the embodiments of the present disclosure may further have the following additional technical features.

It can be understood that the thickness of each material layer has an effect on the penetration of light, and if the thickness of each material layer is too large, a larger blocking effect on the penetration of the light will be produced, so that the 3D effect of fired art glass presented by the film structure for a window glass is affected, manufacturing materials are also wasted; and if the thickness of each material layer is too small, the effect of blurring the window glass cannot be well achieved. Therefore, in an optional embodiment, each of the transparent relief units 5 has a thickness of 0.025 mm-0.6 mm, the pattern layer 4 has a thickness of 0.005 mm-0.05 mm, and the transparent film layer 2 has a thickness of 0.05 mm-0.8 mm. The thickness of each of the transparent relief units 5, the thickness of the pattern layer 4 and the thickness of the transparent film layer 2 may be selected from the above specific parameters according to actual requirements. By using the above parameters, after the light passes through the film structure for a window glass of the embodiments of the present disclosure, the film structure for a window glass can well present the 3D effect of the fired art glass, the manufacturing materials can be utilized reasonably, the waste of the manufacturing materials can be avoided, and the cost can be saved. In other embodiments, the thickness of each of the transparent relief units 5, the thickness of the pattern layer 4 and the thickness of the transparent film layer 2 may use other parameters, which are not limited thereto.

In addition, the width of each of the transparent relief units 5 may affect the diffuse reflection effect of the light, and the size of the spacing 6 between the adjacent transparent relief units 5 may affect the direct transmission effect of the light. Therefore, in an optional embodiment, each of the transparent relief units 5 has a width of 0.1 mm-8 mm, and the spacing 6 between the adjacent transparent relief units 5 is 0.1 mm or above. The specific parameters in the above ranges may be selected for the width of each of the transparent relief units 5 and the size of the spacing 6 between the adjacent transparent relief units 5 according to actual requirements. By using the above parameters, after the light passes through the film structure for a window glass of the embodiments of the present disclosure, the film structure for a window glass can well present the 3D effect of the fired art glass. In other embodiments, the width of each of the transparent relief units 5 and the size of the spacing 6 between the adjacent transparent relief units 5 may use other parameters, which are not limited thereto.

In an optional embodiment, the width of each of the transparent relief units 5 is greater than the width of the adjacent spacing 6, so that after the light passes through the film structure for a window glass of the embodiments of the present disclosure, the film structure for a window glass can well present the 3D effect of the fired art glass. In other embodiments, the width of some of the transparent relief units 5 may be greater than the width of the adjacent spacing 6, the width of each of the transparent relief units 5 may be less than the width of the adjacent spacing 6, the width of some of the transparent relief units 5 may be less than the width of the adjacent spacing 6, the width of each of the transparent relief units 5 may be equal to the width of the adjacent spacing 6, or the width of some of the transparent relief units 5 may be equal to the width of the adjacent spacing 6. This can be set according to actual requirements.

In some application scenarios, the window is required to present the effect of a colorful art glass, but the costs for manufacturing the colorful art glass are high. Therefore, in an optional embodiment, the pattern layer 4 in the film structure for a window glass is specifically a painted layer, so that after the light passes through the film structure for a window glass of the embodiments of the present disclosure, the film structure for a window glass can well present the 3D effect of fired colored art glass, and thus the window only needs an ordinary glass, without the need to use the colored art glass with high manufacturing costs.

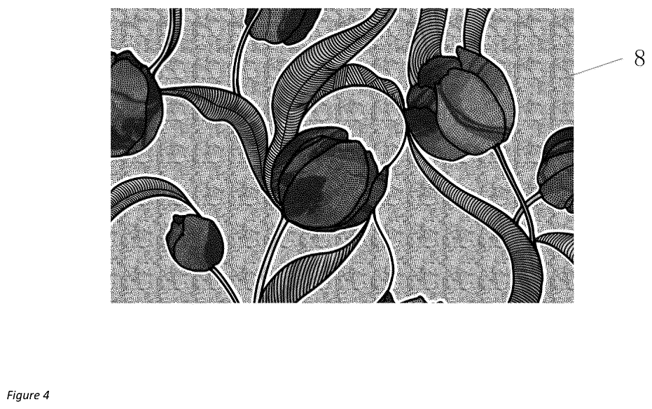

In some application scenarios, after the window uses the film structure for a window glass of the embodiments of the present disclosure, more light is required in a room. Therefore, with reference to FIG. 4, in an optional embodiment, a blank region 8 is provided on a surface of the substrate layer 1 provided with the pattern layer 4, and a plurality of transparent relief units 5 are disposed in the blank region 8. That is, each of the transparent relief units 5 in the blank region 8 is disposed on the substrate layer 1. The number of transparent relief units 5 may be set according to actual requirements. By disposing the blank region 8 on the surface of the substrate layer 1 provided with the pattern layer 4, more light can be allowed to pass through, and thus the requirement for more light in the room can be met. Moreover, the plurality of transparent relief units 5 are disposed in the blank region 8, so that a blurring effect can be enhanced in the blank region 8, and a phenomenon is further avoided that the indoor situation is observed from outdoors through the blank region 8. In other embodiments, no blank region 8 may be provided, or no transparent relief units 5 may be disposed in the blank region 8.

In an optional embodiment, the distribution density of the transparent relief units 5 in the blank region 8 is greater than the distribution density of the transparent relief units 5 on the pattern layer 4, so that the transparent relief units 5 can be reasonably distributed, the blurring effect can be greatly improved in the blank region 8 thanks to the larger distribution density of the transparent relief units 5 in the blank region 8, and the phenomenon is further avoided that the indoor situation is observed from outdoors through the blank region 8. Since the pattern layer 4 has a certain blocking effect in the present disclosure, the distribution density of the transparent relief units 5 thereon may be set to be smaller, a very good texture effect can also be presented, and manufacturing materials can be saved by reasonably distributing the transparent relief units 5. In other embodiments, the distribution density of the transparent relief units 5 in the blank region 8 may be equal to the distribution density of the transparent relief units 5 on the pattern layer 4, or the distribution density of the transparent relief units 5 in the blank region 8 may be less than the distribution density of the transparent relief units 5 on the pattern layer 4.

Referring to FIG. 4, in an optional embodiment, no transparent relief units 5 are disposed in the blank region 8 close to an outer contour line of a pattern in the pattern layer 4, so that the outer contour line of the pattern can be rendered more clearly with a batter visual effect, and the number of transparent relief units 5 manufactured can also be reduced, thereby saving the cost. In other embodiments, a plurality of transparent relief units 5 may be disposed in the blank region 8 close to the outer contour line of the pattern in the pattern layer 4.

In the embodiments of the present disclosure, the manufacturing material of each of the transparent relief units 5 is not limited, but may be set according to the actual requirements. In an optional embodiment, each of the transparent relief units 5 is made of a UV coating which is functionally suitable for the film structure for a window glass. The light can be well diffusely reflected when passing through each of the transparent relief units 5 made of a UV coating, so that after the light passes through the film structure for a window glass of the embodiments of the present disclosure, the film structure for a window glass can well present the 3D effect of the fired art glass.

It can be understood that, a conventional printed textured glass film needs plate making and engraved plate printing, resulting in both a low manufacturing efficiency and a low light transmittance of the manufactured glass film. In the embodiments of the present disclosure, each of the transparent relief units 5 made of a UV coating may be formed by, but not limited to, a spraying process, so that the film structure for a window glass of the embodiments of the present disclosure can be formed in one layer only by means of one-time printing, the manufacturing efficiency is high, and the light transmittance of the manufactured film structure for a window glass can be improved.

In the embodiments of the present disclosure, the manufacturing material of the transparent film layer 2 is not limited, but may be set according to the actual requirements. In an optional embodiment, the transparent film layer 2 is made of a PVC material, which is not only functionally suitable for the film structure for a window glass, but also has low costs.

Compared with the prior art, according to the film structure for a window glass of the embodiments of the present disclosure, by disposing the plurality of transparent relief units on the surface of the pattern layer facing away from the transparent film layer, the film structure for a window glass has a bumpy texture, light passing through each of the transparent relief units is diffusely reflected, and the light passing through the spacing between adjacent transparent relief units is directly transmitted, so that the 3D effect of fired art glass can be more realistically presented. The film structure for a window glass of the embodiments of the present disclosure can present the above effect indoors and outdoors. In addition, by disposing each of the transparent relief units in an arc shape on the side facing away from the pattern layer, the light passing through each of the transparent relief units can have a better diffuse reflection effect, and the manufacturing process for each of the transparent relief units can also be more adaptable, making each of the transparent relief units easier to manufacture with a high manufacturing efficiency.

Those skilled in the art can freely combine and use the above additional technical features provided that no conflict occurs.

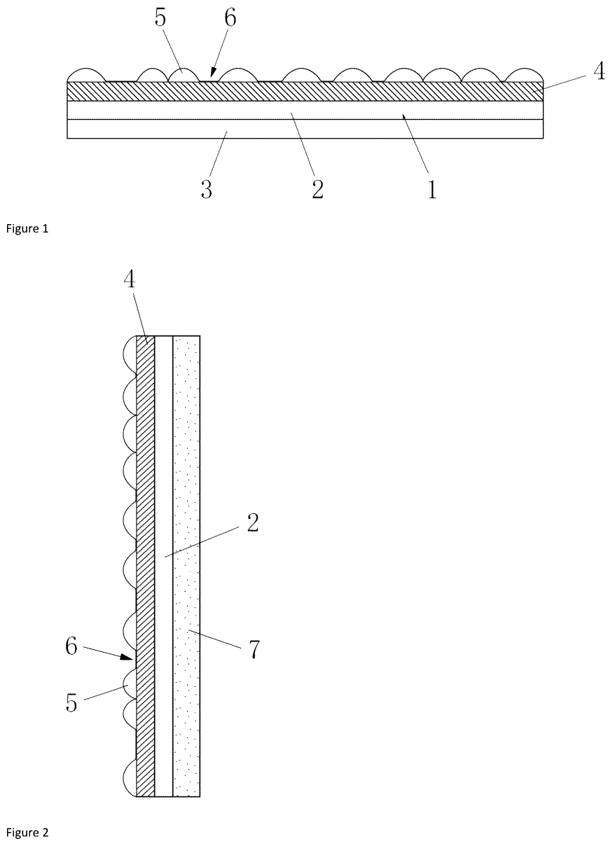

Referring to FIG. 2, the embodiments of the present disclosure further provide a window. The window includes a glass body 7 and a film structure for a window glass as described above. The film structure for a window glass is disposed on the glass body 7. Since the window uses the film structure for a window glass as described above, the window likewise has the bumpy texture, the light passing through each of the transparent relief units 5 may be diffusely reflected, and the light passing through the spacing 6 between adjacent transparent relief units 5 is directly transmitted, so that the flat pattern layer 4 can more realistically present the 3D effect of fired art glass. The window of the embodiments of the present disclosure can present the above effect indoors and outdoors. In addition, by disposing each of the transparent relief units 5 in an arc shape on the side facing away from the pattern layer 4, the light passing through each of the transparent relief units 5 can have a better diffuse reflection effect, and the manufacturing process for each of the transparent relief units 5 can also be more adaptable, making each of the transparent relief units 5 easier to manufacture with a high manufacturing efficiency.

The foregoing implementations are only preferred implementations of the embodiments of the present disclosure and cannot be used to limit the scope of protection of the embodiments of the present disclosure. All non-essential modifications and substitutions made by those skilled in the art on the basis of the embodiments of the present disclosure shall fall within the scope of protection of the embodiments of the present disclosure.

1. A film structure for a window glass, the film structure comprising:
a substrate layer, comprising a transparent film layer and a backing paper layer, the transparent film layer being disposed on the backing paper layer; and
a pattern layer disposed on a surface of the transparent film layer facing away from the backing paper layer, a plurality of transparent relief units being disposed on a surface of the pattern layer facing away from the transparent film layer, and a spacing being left between some of adjacent transparent relief units;
wherein a cross section of each of the transparent relief units in a direction perpendicular to the pattern layer is disposed in an arc shape on a side facing away from the pattern layer.

2. The film structure for a window glass according to claim 1, wherein the transparent relief unit has a thickness of 0.025 mm-0.6 mm, the pattern layer has a thickness of 0.005 mm-0.05 mm, and the transparent film layer has a thickness of 0.05 mm-0.8 mm.

3. The film structure for a window glass according to claim 1, wherein the transparent relief unit has a width of 0.1 mm-8 mm, and the spacing between the adjacent transparent relief units is 0.1 mm or above.

4. The film structure for a window glass according to claim 1, wherein the width of the transparent relief unit is greater than the width of the adjacent spacing.

5. The film structure for a window glass according to claim 1, wherein the pattern layer is a painted layer.

6. The film structure for a window glass according to claim 5, wherein a blank region is provided on a surface of the substrate layer provided with the pattern layer, and a plurality of transparent relief units are disposed in the blank region.

7. The film structure for a window glass according to claim 6, wherein the distribution density of the transparent relief units in the blank region is greater than the distribution density of the transparent relief units on the pattern layer.

8. The film structure for a window glass according to claim 6, wherein no transparent relief units are disposed in the blank region close to an outer contour line of a pattern in the pattern layer.

9. The film structure for a window glass according to claim 1, wherein the transparent relief unit is made of a UV coating.

10. A window, comprising: a glass body and a film structure for a window glass, the film structure for a window glass being disposed on the glass body;
wherein the film for a window glass comprises:
a structural substrate layer, comprising a transparent film layer and a backing paper layer, the transparent film layer being disposed on the backing paper layer; and
a pattern layer disposed on a surface of the transparent film layer facing away from the backing paper layer, a plurality of transparent relief units being disposed on a surface of the pattern layer facing away from the transparent film layer, and a spacing being left between some of adjacent transparent relief units;
wherein a cross section of each of the transparent relief units in a direction perpendicular to the pattern layer is disposed in an arc shape on a side facing away from the pattern layer.
